(19) United States
(12) Patent Application Publication
(10) Pub. No.: US 2015/0049180 A1
(43) Pub. Date: Feb. 19, 2015

(54) MICROSCOPE

(71) Applicant: Carl Zeiss Microscopy GmbH, Jena (DE)

(72) Inventors: Enrico GEIßLER, Jena (DE); Alexander GAIDUK, Jena (DE); Dominik STEHR, Jena (DE); Markus JÄGER, Leipzig (DE)

(21) Appl. No.: 14/457,299

(22) Filed: Aug. 12, 2014

(30) Foreign Application Priority Data
Aug. 19, 2013 (DE) 10 2013 216 409.2

(51) Int. Cl. G02B 21/36

(52) U.S. Cl. CPC G02B 21/365
USPC 348/80

(57) ABSTRACT

Provided is a microscope comprising a recording unit, having a magnifying imaging optical unit and an image module, for recording images of a sample with a first image frequency and a digital evaluation unit, to which the recorded images are supplied and which carries out predetermined image processing based on the recorded images and produces, as a result, output images with a second image frequency that is smaller than the first image frequency or equal to the first image frequency and can transfer them to an output unit for representation.

### TECHNICAL FIELD

The present invention relates to a microscope, in particular to a digital microscope.

### SUMMARY OF THE INVENTION

Microscopes of this type are frequently used to analyze materials. To this end, typically an image of the sample is generated and represented.

It is an object of the invention to make available an improved microscope.

The object is achieved by a microscope comprising a recording unit, having a magnifying imaging optical unit and an image module, for recording images of a sample with a first frequency (or first image frequency), and a digital evaluation unit, to which the recorded images are supplied and which carries out predetermined image processing of the recorded images and produces, as a result, output images with a second frequency (or second image frequency) that is smaller than the first frequency or equal to the first frequency and can transfer them to an output unit for representation.

The microscope according to the invention is therefore used to record image data faster than they are represented, such that as a result further functions may be provided.

In particular, the digital evaluation unit has at least one FPGA (field programmable gate array). An FPGA is thus an integrated circuit of the digital technology in which the basic function of individual universal blocks and their interconnection can be determined by way of programming structure rules. It is therefore also appropriate to refer to it as a configuration of the FPGA. Such an FPGA can be used to make available the computational power necessary for carrying out the desired image processing. In particular, processing is possible which is so quick that the output images can be represented in real time.

In the microscope according to the invention, the image module can comprise an image sensor with a native interface, wherein the image sensor data (that is to say the data of the image sensor) is transferred directly to the FPGA via the native interface. Quick image processing can thus be ensured.

For example, the second frequency can be at least 24 Hz or 25 Hz. Furthermore, the first frequency is preferably at least twice as large as the second frequency and can be in the range of up to 300 Hz.

The digital evaluation unit can furthermore have at least one digital signal processor. This in turn increases the computational power for the image processing and the generation of the output images.

The evaluation unit is configured in particular as hardware provided within the microscope and is in particular not a conventional computer, but specialized hardware configured and optimized for the predetermined image processing.

The digital evaluation unit can generate an (individual) output image on the basis of at least two recorded images. In particular, said digital evaluation unit can generate for example HDR output images.

The microscope according to the invention can have a sample stage for holding the sample and a moving unit for carrying out a relative movement between the sample stage and the recording unit, with the image recording with the first frequency and the relative movement being synchronized with one another. It is additionally possible for the digital evaluation unit to make available for selection several image recording modes which differ in terms of the predetermined image processing to be carried out.

The output unit can be a constituent part of the microscope. The microscope can furthermore also have an input unit.

Moreover, the digital evaluation unit can also serve as a control unit for the microscope. In particular, the digital evaluation unit can control the relative movement between the sample stage and the recording unit, the illumination condition, the optical magnification, or any other settings of the microscope. It can also control the recording unit and in particular the image module.

The image module can have one or more image sensors. The image sensor or sensors may be for example a CCD sensor or a CMOS sensor.

The digital evaluation unit can realize or make available for selection as predetermined image data processing for example dynamic compression, white balance, autofocus, image stabilization, recording of a z-stack of images (that is to say several recordings with different focus settings), image representation with increased depth of field, different contrast methods etc. In particular, various ones of said image processing modes can also be made available in combination with one another.

The microscope can have further elements known to the person skilled in the art which are necessary for operating the microscope. It should be appreciated that the previously mentioned features and the features which will be explained below can be used not only in the stated combinations, but also in other combinations or alone without departing from the scope of the present invention.

### BRIEF DESCRIPTION OF THE DRAWINGS

The invention will be explained in more detail below by way of example with reference to the attached drawings, which also disclose features that are essential to the invention.

The accompanying drawings, which are incorporated into this specification, illustrate one or more exemplary embodiments of the inventions disclosed herein and, together with the detailed description, serve to explain the principles and exemplary implementations of these inventions. One of skill in the art will understand that the drawings are illustrative only, and that what is depicted therein may be adapted based on the text of the specification and the spirit and scope of the teachings herein.

In the drawings, where like reference numerals refer to like reference in the specification:

FIG. 1 shows a schematic illustration of an embodiment of the microscope according to the invention,

FIG. 2 shows a schematic illustration for explaining the operation of the microscope according to the invention,

FIG. 3 shows a further illustration for explaining the operation of the microscope according to the invention, and

FIG. 4 shows a schematic illustration of parts of the digital evaluation unit 7 of the microscope according to FIG. 1.

### DETAILED DESCRIPTION

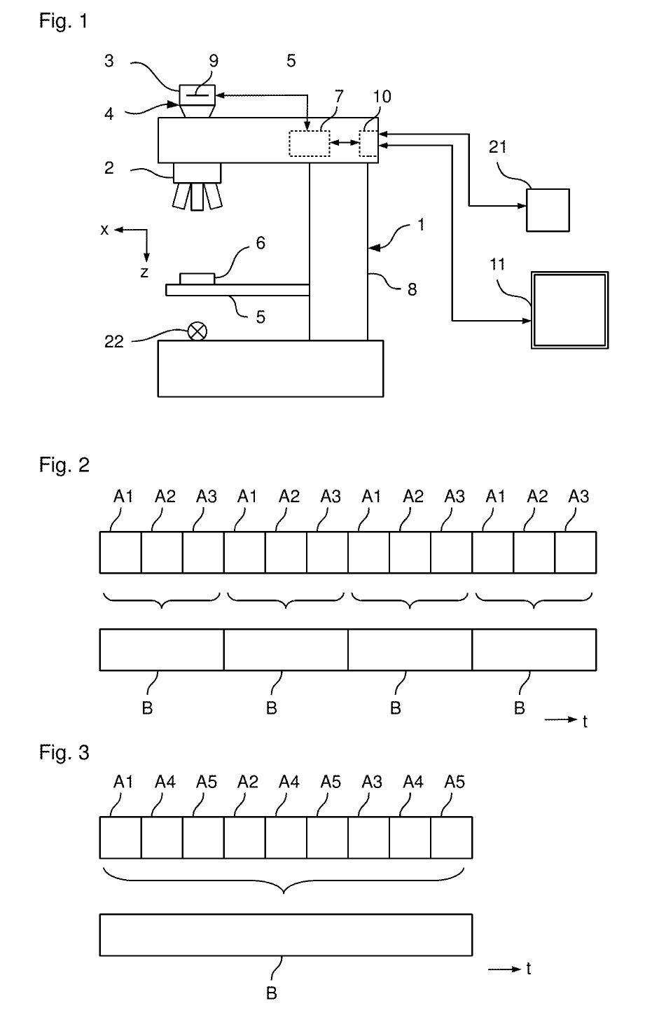

In the embodiment of FIG. 1, the microscope (or digital microscope) 1 according to the invention comprises a recording unit 4 having a magnifying imaging optical unit 2 and an image module 3, a sample stage 5 for holding a sample 6, and a digital evaluation unit 7. Furthermore, the microscope 1 comprises a movement unit 8, which is indicated by the stand-like construction, which movement unit 8 can move the sample stage 5 relative to the imaging optical unit 2 in the z-direction, in the x-direction and in the direction that is perpendicular to the plane of the drawing, and an illumination unit 22 for illuminating the sample 6.

Plotted schematically here for the imaging optical unit 2 is a nosepiece having three objectives. The image module 3 includes an image sensor 9 (for example a CCD sensor or a CMOS sensor) and is connected to the digital evaluation unit 7.

During operation of the microscope 1, the image module 3 records images of the sample 6 with a first frequency, and the images (or the digital image data) are supplied to the evaluation unit 7, which carries out digital image processing. Output images with a second frequency that is smaller than the first frequency are generated by the evaluation unit 7 and delivered to an output unit 11 (in the present case for example a screen), which can then represent the output images with the second frequency, via an interface 10, which can be a constituent part of the evaluation unit 7.

In the microscope 1 according to the invention, data acquisition (recording of the images) and data processing are thus carried out in the digital evaluation unit 7 with a higher frequency (or higher image frequency) than the frequency or image frequency with which the output images are then generated. This can be utilized to extend the function of the microscope according to the invention. For example, the output images can thus be produced as what are known as HDR images (images with a high dynamic range) by calculating and producing an output image B for example from in each case three successive recordings A1, A2 and A3 (FIG. 2). FIG. 2 schematically illustrates the recorded images A1, A2 and A3 and the output images B along a time axis t. The individual images A1-A3 are of course recorded preferably with different exposure conditions (for example exposure times) in order to then be able to calculate the desired HDR output images B. The output images B can thus be generated in real time and be represented as video or video stream via the output unit 11 in real time with the second frequency.

It is also possible to combine a plurality of functions. For example it is furthermore possible to generate HDR images B with a desired second frequency from the recordings A1-A3. At the same time it is possible, within the time for the image recordings for each HDR image, for further recordings or images A4 to be used for carrying out automatic focusing and for further recordings or images A5 to be used for carrying out image stabilization such that the image quality of the HDR output images B is further increased. This is illustrated schematically in FIG. 3.

The computational power necessary therefor for the digital evaluation unit 7 can be provided according to the invention, because the evaluation unit 7 preferably has at least one FPGA 12 (field programmable gate array) and preferably at least one digital signal processor 13. By using the FPGA 12, the desired function can be provided and a selection of one of a plurality of functions can be made by the user and then also realized immediately in particular via a schematically illustrated input unit 21. The input unit 21 can be for example a conventional computer, a tablet, a smart phone or another apparatus. The connection between the input unit 21 and the digital evaluation unit 7 and between the output unit 11 and the digital evaluation unit 7 can be wireless or wired.

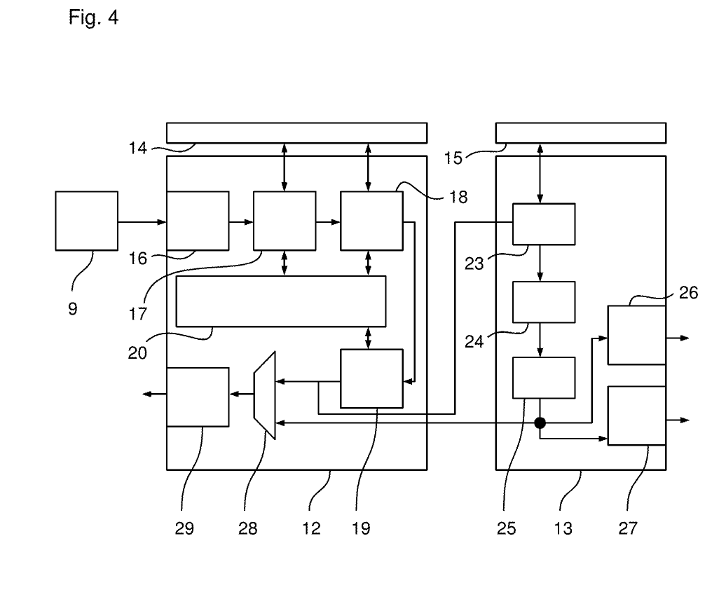

FIG. 4 shows a schematic function illustration of the FPGA 12 and of the digital signal processor 13, which can in each case access a memory 14, 15. The data of the image sensor 9 is supplied to various function blocks 17, 18, 19 via a frame format unit 16, which function blocks can communicate with a register unit 20 and the memory 14 and carry out the desired image processing. Corresponding processing in function blocks 23, 24, 25 of the signal processor 13 can also be carried out. In that case, the data can be output via various interfaces. To this end, a Wi-Fi encoder 26 for wireless transmission and an HDMI format unit 27 for outputting as an HDMI signal are provided in the signal processor, and in the FPGA 12 a logic gate 28 and a USB3 format unit 29 for delivering the output images via a USB3 interface.

Since the digital evaluation unit 7 has the FPGA 12 and the digital signal processor 13, the described image data processing can be carried out in real time. This is hardly possible with a conventional computer, since most operating systems are not real-time operating systems at all, and therefore a correspondingly quick real-time processing cannot be ensured.

The digital evaluation unit 7 is provided as a separate hardware unit in the microscope 1 according to the invention and outputs the desired output images.

Moreover, the digital evaluation unit 7 can also be used as a control unit for the microscope 1 which controls for example optical magnification, illumination conditions, sample-stage movement or other microscope settings.

Further functions can be provided with the microscope according to the invention and in particular the digital evaluation unit 7. For example, automatic white balance can be carried out, dynamic compression for the generated images can be carried out, and what is known as color co-site sampling can be carried out, for example. In color co-site sampling, the sample is recorded a number of times, wherein between recordings the image sensor 9 is displaced in one direction (for example using piezo actuators) by, for example, one pixel. It is therefore possible in that case to achieve complete color information for each pixel, since image sensors are typically configured such that they have a color filter so that each pixel can record for example only one of the three primary colors red, green or blue. By suitably displacing the image sensor, each image point is then recorded by a corresponding pixel such that all color channels at each image point can be recorded completely.

It is furthermore possible to realize different contrast and/or recording methods, for example it is possible to carry out bright-field recording, dark-field illumination, differential interference contrast and segmented illumination.

The first frequency for image recording can be in particular a multiple of the second frequency. The second frequency, for example, can be at least 24 or 25 or 30 Hz, and the first frequency can therefore be at least 48, 50, 60 Hz. It can also be for example 100, 150 or 300 Hz.

The construction of the microscope described here in connection with FIG. 1 is to be understood to be purely an example. The configuration according to the invention using the digital evaluation unit 7 can be realized in any known microscope type. The microscope 1 described here is preferably configured for material analysis.

In the microscope according to the invention, furthermore a greater region can be recorded using the image sensor 9 than the region of the recording that will then be used to generate the output images. Those parts of the recording not represented in the output image can be used for other functions of the microscope, for example for automatic focusing and/or automatic image stabilization.

Although some of various drawings illustrate a number of logical stages in a particular order, stages which are not order dependent can be reordered and other stages can be combined or broken out. Alternative orderings and groupings, whether described above or not, can be appropriate or obvious to those of ordinary skill in the art of computer science. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to be limiting to the precise forms disclosed. Many modifications and variations are possible in view of the above teachings. The embodiments were chosen and described in order to best explain the principles of the aspects and its practical applications, to thereby enable others skilled in the art to best utilize the aspects and various embodiments with various modifications as are suited to the particular use contemplated.

This application is based on and claims the benefit of priority from German Patent Application No. 10 2013 216 409.2, filed on Aug. 19, 2013, the contents of which are incorporated by reference.

1. A microscope comprising:
a recording unit, having a magnifying imaging optical unit and an image module, for recording images of a sample with a first image frequency and
a digital evaluation unit, to which the recorded images are supplied and which carries out predetermined image processing based on the recorded images and produces, as a result, output images with a second image frequency that is smaller than the first image frequency or equal to the first image frequency and can transfer them to an output unit for representation.

2. The microscope as claimed in claim 1, in which the digital evaluation unit has at least one FPGA.

3. The microscope as claimed in claim 1, in which the image module has an image sensor with a native interface, wherein the image sensor data is transmitted directly to the FPGA via the native interface.

4. The microscope as claimed in claim 1, in which the digital evaluation unit has at least one digital signal processor.

5. The microscope as claimed in claim 1, in which the digital evaluation unit is configured as hardware provided within the microscope.

6. The microscope as claimed in claim 1, in which the second image frequency is at least 24 Hz.

7. The microscope as claimed in claim 1, in which the first image frequency is at least twice as large as the second image frequency.

8. The microscope as claimed in claim 1, in which the digital evaluation unit generates and outputs the output images in real time.

9. The microscope as claimed in claim 1, in which the digital evaluation unit generates an output image based on at least two recorded images.

10. The microscope as claimed in claim 1, comprising a sample stage for holding the sample and a moving unit for carrying out a relative movement between the sample stage and the recording unit, with the image recording with the first image frequency and the relative movement being synchronized with one another.

11. The microscope as claimed in claim 1, in which the digital evaluation unit makes available for selection several image recording modes which differ in terms of the predetermined image processing to be carried out.
